(19) United States
(12) Patent Application Publication
(10) Pub. No.: US 2019/0212248 A1
(43) Pub. Date: Jul. 11, 2019

(54) RECORDING MEDIUM RECORDING DISTORTION CALCULATION PROGRAM, DISTORTION CALCULATION METHOD, AND INFORMATION PROCESSING APPARATUS OF CALCULATING DISTORTION

(71) Applicant: FUJITSU LIMITED, Kawasaki-shi (JP)

(72) Inventors: MAMI NAKADATE, Yokohama (JP); Kanako IMAI, Sagamihara (JP); Yukari Sato, Inagi (JP)

(73) Assignee: FUJITSU LIMITED, Kawasaki-shi (JP)

(21) Appl. No.: 16/239,585

(22) Filed: Jan. 4, 2019

(30) Foreign Application Priority Data
Jan. 11, 2018 (JP) 2018-002821

(51) Int. Cl. G01N 19/08; G01N 3/08; G01N 19/04; G06F 17/50

(52) U.S. Cl. CPC G01N 19/08; G01N 3/08; G06F 2217/76; G06F 17/5009; G01N 19/04

(57) ABSTRACT

A non-transitory computer-readable recording medium storing a distortion calculation program that causes a computer to execute a process includes: analyzing a distortion which occurs in an object when stress is applied, referring to a storage which stores a distortion amplitude for each of nodes of a mesh which is created for the object, moving, onto a circumference which is determined by a set radius, one or more nodes within a width set from the circumference by using a point selected from the nodes of the mesh as a starting point, creating a distribution chart of values of the distortion amplitude of the one or more nodes on the circumference after movement, and displaying the distribution chart on a display device.

### CROSS-REFERENCE TO RELATED APPLICATION

This application is based upon and claims the benefit of priority of the prior Japanese Patent Application No. 2018-002821, filed on Jan. 11, 2018, the entire contents of which are incorporated herein by reference.

### FIELD

The embodiments discussed herein are related to a distortion calculation program, a distortion calculation method, and an information processing apparatus of calculating a distortion.

### BACKGROUND

In recent years, in various fields where a product development is made, the durability of the product is verified at a design stage, and a damaged state of a portion where damage such as distortion or crack occurs or a portion where the damage is easily generated is analyzed by simulation.

As a technique related to such a simulation, a technique is known which calculates a distribution of lifetimes at the time of no damage from a distribution of a distortion amplitude using the Manson-Coffin rule, and calculates a crack propagation speed by applying a cumulative linear damage law to estimate a fracture life of a solder bonding portion.

A technique is proposed which easily and rapidly predicts reliability and lifetime of the solder bonding portion in an electronic device by previously associating an amount of distortion occurring in the solder bonding portion and a response curve or a response phase indicating the distortion amount with a positional relationship between electronic components.

Related techniques are disclosed in, for example, Japanese Laid-open Patent Publication Nos. 2006-071406, 2004-079914, and 2000-304630.

### SUMMARY

A non-transitory computer-readable recording medium storing a distortion calculation program that causes a computer to execute a process includes: analyzing a distortion which occurs in an object when stress is applied, referring to a storage which stores a distortion amplitude for each of nodes of a mesh which is created for the object, moving, onto a circumference which is determined by a set radius, one or more nodes within a width set from the circumference by using a point selected from the nodes of the mesh as a starting point, creating a distribution chart of values of the distortion amplitude of the one or more nodes on the circumference after movement, and displaying the distribution chart on a display device.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIGS. 1A and 1B are diagrams for describing a fatigue life prediction procedure;

FIG. 2 is a diagram for describing a procedure of extracting a distortion amplitude of interest in plastic distortion amplitude evaluation;

FIG. 3 is a diagram illustrating a hardware configuration of an information processing apparatus;

FIG. 4 is a diagram illustrating a functional configuration example of the information processing apparatus;

FIG. 5 is a flowchart for describing a distortion amplitude evaluation process;

FIG. 6 is a diagram for describing a relationship between data;

FIG. 7 is a diagram illustrating a screen example for acquiring projection setting information;

FIG. 8 is a diagram illustrating a distribution example within a distance;

FIG. 9 is a diagram illustrating a distribution example within a margin range in a cross section;

FIGS. 10A and 10B are diagrams illustrating a comparative example in the case of a solder ball;

FIGS. 11A and 11B are diagrams illustrating a comparative example in the case of a bar-shaped solder; and

FIG. 12 is a diagram illustrating an example of a spherical cut surface.

### DESCRIPTION OF EMBODIMENTS

For example, in a case where a product is an electronic device, in order to display a distortion amplitude of a cross section at a location where the distortion amplitude of a solder bump surface that bonds an electronic component in the electronic device is the maximum, a node of a tetrahedral element or a hexahedron element constituting a solder model needs to be present on the desired cross section.

However, experience and advanced skills by experts are required in order to create a solder model so that the node of the tetrahedron or hexahedron element lies on the cross section of a portion having a largest distortion amplitude.

Therefore, one aspect is to facilitate extraction of a distortion on a cross section of a portion where stress is applied to an object.

Hereinafter, embodiments of the present disclosure will be described based on drawings. First, the related art will be described. In the embodiments to be described below, a case of calculating an amplitude of a distortion which occurs in a solder by a simulation and predicting a fatigue life of the solder is described by using a solder bonding portion as an example, but the embodiments are not limited to the solder bonding portion.

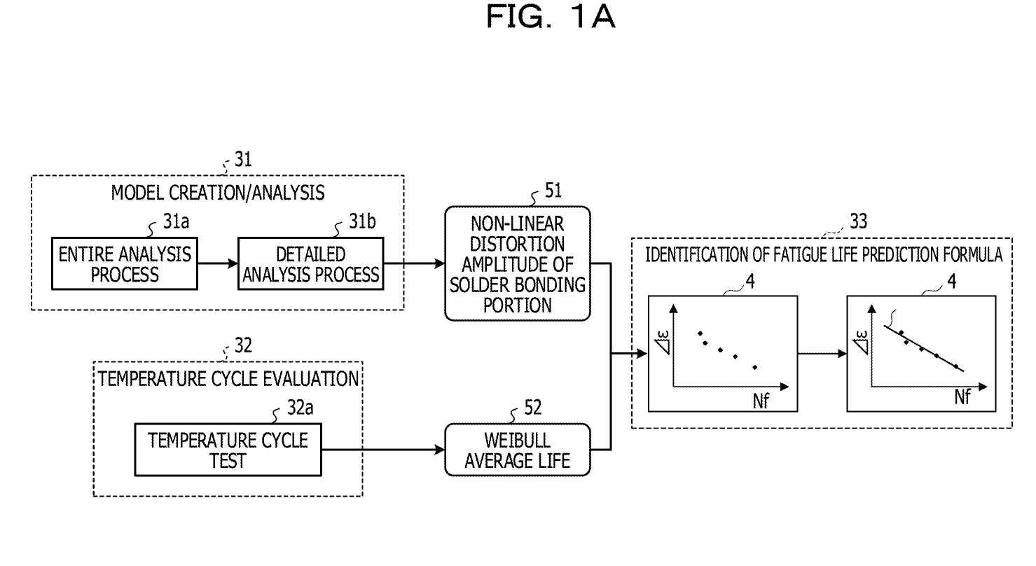

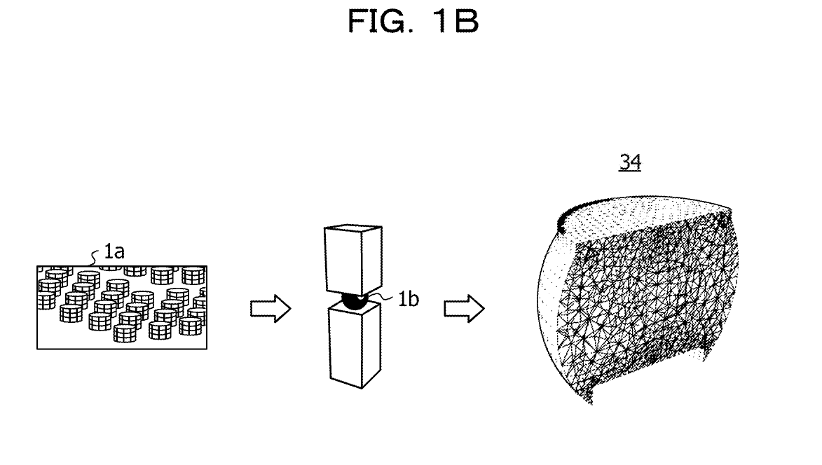

FIGS. 1A and 1B are diagrams for describing a fatigue life prediction procedure. FIG. 1A illustrates an overall flow of the fatigue life prediction procedure and FIG. 1B illustrates a model example, a display example, etc. which are obtained in a step of each process to correspond to FIG. 1A.

In FIG. 1A, in model creation/analysis 31, an entire analysis process 31a and a detailed analysis process 31b are performed by the simulation. In the entire analysis process 31a, when a device is a chip (semiconductor device), etc., a model (entire model 1a of FIG. 1B) of a solder bump bonded with a substrate is created and a distortion amplitude (may be simply referred to as a distortion) is calculated in bonding of each solder bump with the substrate. In a detailed analysis process 31b, a solder bump having a large distortion amplitude is selected, a model (detailed model 1b of FIG. 1B) of the selected solder bump is created, the distortion amplitude is specifically calculated with respect to one solder bump, and distortion amplitude detailed data 51 indicating the calculated distortion amplitude is obtained. The distortion amplitude detailed data 51 is an example of an analysis value.

Meanwhile, a temperature cycle evaluation 32 is performed by a temperature cycle test 32a using an actual chip. The temperature cycle evaluation 32 is performed based on at least three conditions according to an energization evaluation, cross section observation and the like, and life data 52 is obtained which indicates a Weibull average life obtained by calculating the distribution of the distortion amplitude by using a Manson-Coffin rule with respect to information such as an obtained numerical value.

Identification 33 of a fatigue life prediction formula is performed using the obtained distortion amplitude detailed data 51 and life data 52. An SN line diagram 4 representing a relationship between a nonlinear distortion amplitude Δε and a Weibull average break life Nf is created and a value plotted to the SN line diagram 4 is approximated by the Manson-Coffin rule to obtain a fatigue life curve 5.

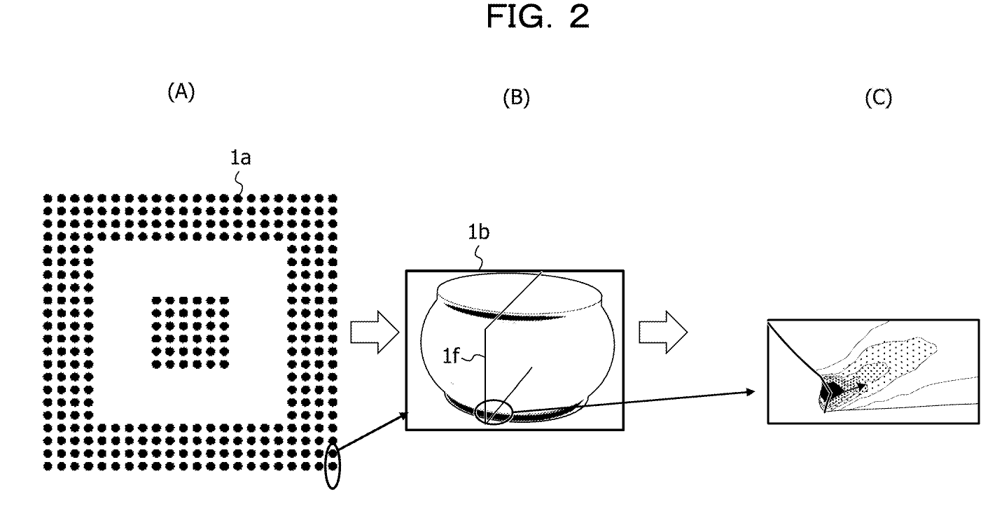

A plastic distortion amplitude evaluation 34 using the distortion amplitude detailed data 51 is performed (FIG. 1B). A plastic distortion amplitude evaluation 34 is described in FIG. 2. FIG. 2 is a diagram for describing a procedure of extracting a distortion amplitude of interest in plastic distortion amplitude evaluation. In FIG. 2(A), in a terminal used by a designer, an entire model 1a is displayed according to an instruction of the designer. The designer may select a solder bump representing a maximum distortion amplitude.

When the distortion amplitude on the surface of the selected solder bump is simulated and displayed (FIG. 2(B)), the designer designates a location of a cross section where the distortion amplitude is evaluated in the solder bump in a part having a large distortion amplitude. For example, the designer designates a location (e.g., a location having the largest distortion amplitude) on the detailed model 1b.

A cross section 1f at the location designated by the designer on the detailed model 1b of the solder bump is created and the distortion amplitude in the cross section 1f is simulated (FIG. 2(C)). For example, in the case of the solder bump, the designer attempts to extract a creep distortion amplitude at a location of 50 μm from the location designated on the detailed model 1b to the inside from a simulation result of the cross section 1f.

However, since the distortion amplitude in the cross section 1f is obtained from the node existing on the cross section 1f, unless a mesh is created such that the node exists on the cross section 1f, a maximum value of the distortion amplitude may not be obtained and may not be displayed on the cross section 1f.

In the embodiment, it is easy to obtain the maximum distortion amplitude in the cross section 1f illustrated in FIG. 2(C). Further, in the embodiment to be described below, an element expressing a shape such as a curved surface is not limited to elements such as the tetrahedron element and the hexahedron element.

The model creation/analysis 31, the identification 33 of the fatigue life prediction formula, and the plastic distortion amplitude evaluation 34 are implemented by the information processing apparatus and in the embodiment, a structure of the plastic distortion amplitude evaluation 34 is improved. First, a hardware configuration of the information processing apparatus in the embodiment will be described.

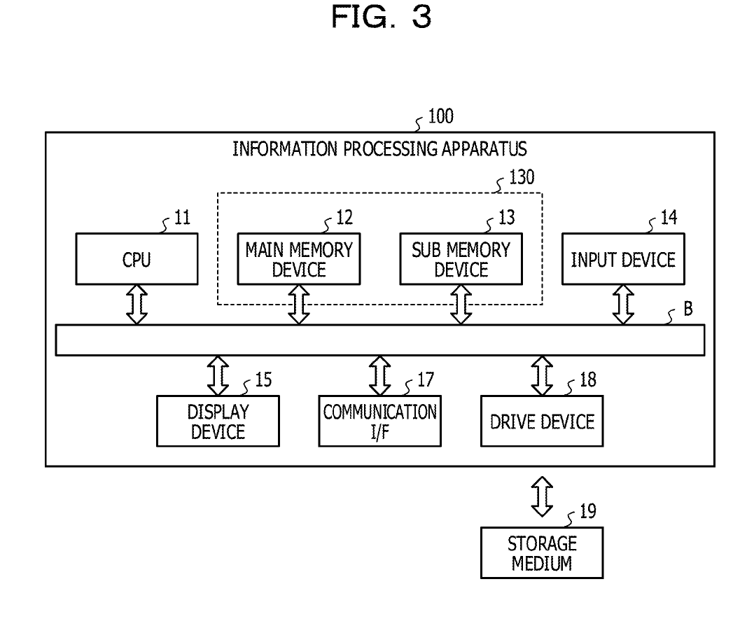

FIG. 3 is a diagram illustrating a hardware configuration of an information processing apparatus. In FIG. 3, the information processing apparatus 100 which serves as an information processing apparatus controlled by a computer includes a central processing unit (CPU) 11, a main memory device 12, a sub memory device 13, an input device 14, a display device 15, a communication interface (I/F) 17, and a drive device 18 and is coupled to a bus B.

The CPU 11 corresponds to a processor that controls the information processing apparatus 100 according to a program stored in the main memory device 12. As for the main memory device 12, a random access memory (RAM), a read only memory (ROM), and the like are used, and the main memory device 12 stores or temporarily conserves the program executed by the CPU 11, data used for processing in the CPU 11, data acquired through the processing in the CPU 11, and the like.

As for the sub memory device 13, a hard disk drive (HDD), and the like are used and the sub memory device 13 stores data including a program for executing various processing, and the like. As a portion of the programs stored in the sub memory device 13 is loaded to the main memory device 12 and executed by the CPU 11, various processing is implemented.

The input device 14 has a mouse, a keyboard, and the like and is used for a user to input various information used for the processing by the information processing apparatus 100. The display device 15 displays various information used under the control of the CPU 11. The input device 14 and the display device 15 may be a user interface by an integrated touch panel, and the like. The communication I/F 17 performs communication through a wired or wireless network. The communication by the communication I/F 17 is not limited to the wired or wireless network.

The program that implements the process performed by the information processing apparatus 100 is provided to the information processing apparatus 100 by a storage medium 19 such as, for example, a compact disc read only memory (CD-ROM).

The drive device 18 performs an interface between the storage medium 19 set in the drive device 18 (e.g., the CD-ROM, etc.) and the information processing apparatus 100.

The program that implements various processing according to the embodiment to be described below is stored in the storage medium 19 and the program stored in the storage medium 19 is installed in the information processing apparatus 100 via the drive device 18. The installed program becomes executable by the information processing apparatus 100.

The storage medium 19 which stores the program is not limited to the CD-ROM and may be one or more non-transitory tangible media having a structure, which is computer readable. The computer readable storage media may include portable recording media including a digital versatile disk (DVD), a USB memory, and the like and semiconductor memories including a flash memory, and the like in addition to the CD-ROM.

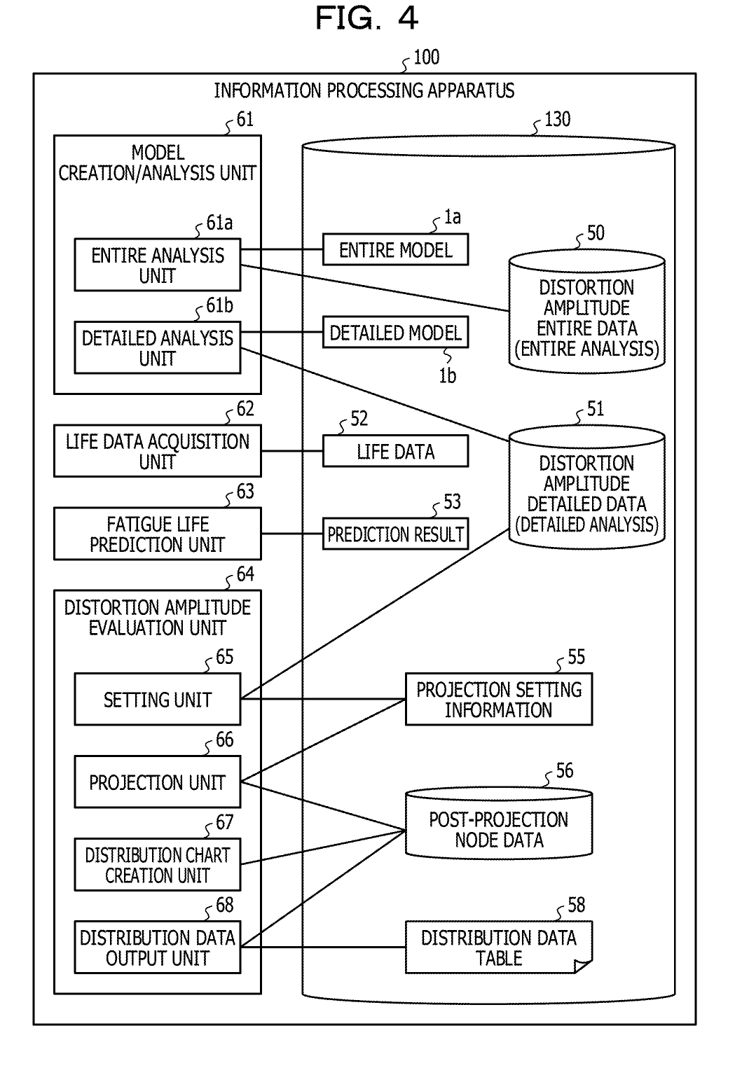

FIG. 4 is a diagram illustrating a functional configuration example of the information processing apparatus. In FIG. 4, the information processing apparatus 100 includes a model creation/analysis unit 61, a life data acquisition unit 62, a fatigue life prediction unit 63, and a distortion amplitude evaluation unit 64. Each of the model creation/analysis unit 61, the life data acquisition unit 62, the fatigue life prediction unit 63, and the distortion amplitude evaluation unit 64 is implemented by executing a program installed in the information processing apparatus 100 by the CPU 11 of the information processing apparatus 100.

A storage unit 130 stores an entire model 1a, a detailed model 1b, distortion amplitude entire data 50, distortion amplitude evaluation data 51, life data 52, a prediction result 53, projection setting information 55, post-projection node data 56, a distribution data table 58, and the like.

The model creation/analysis unit 61 is a processing unit that creates a model in order to analyze the fatigue life of the product and simulates the distortion amplitude and includes an entire analysis unit 61a and a detailed analysis unit 61b. The model creation/analysis unit 61 corresponds to an example of an analysis unit.

The entire analysis unit 61a is a processing unit (corresponding to the entire analysis process 31a in FIG. 1A) that creates the entire model 1a and calculates and simulates the distortion amplitude that may occur in the entire model 1a. In a simulation result obtained by the entire analysis process 31a, at least, the distortion amplitude entire data 50 including a coordinate of a node (vertex) of a mesh for the entire model 1a and a value of the distortion amplitude at the node are stored in the storage unit 130. The entire model 1a may be all products to be analyzed and may be a model created by specifying a material used for a product.

As an example, all the solder bumps of the chip may be the entire model 1a. The simulation result of the distortion amplitude with respect to the entire model 1a may be displayed on the display device 15. Further, the simulation result of the entire model 1a may be displayed so as for a user such as the designer to designate a detailed analysis range such as a component on which the detailed analysis is performed or a part of a product on which the detailed analysis is performed.

The detailed analysis unit 61b is a processing unit (corresponding to the detailed analysis process 31b of FIG. 1A) that performs the simulation by specifically calculating the distortion amplitude of the detailed analysis range (the component, the part of the product, etc.) corresponding to a part of the entire model 1a. In a simulation result obtained by the detailed analysis process 31b, at least, the distortion amplitude detailed data 51 is stored in the storage unit 130 which includes a coordinate of a vertex (node) of a mesh in the detailed analysis range set with respect to the entire model 1a and a value of the distortion amplitude at a location of the coordinate.

The detailed analysis unit 61b may automatically set the detailed analysis range including coordinates in which the distortion amplitude obtained in the entire analysis process 31a represents the maximum value, create a detailed model 1b of the set detailed analysis range, and create a mesh to be finer to calculate the distortion amplitude. Further, the detailed analysis range may be selected by the designer for the entire model 1a displayed on the display device 15.

The life data acquisition unit 62 is a processing unit that receives an input of the life data 52 obtained by the temperature cycle evaluation 32 from the input device 14 or the like and stores the received input in the storage unit 130.

The fatigue life prediction unit 63 is a processing unit that creates the SN line diagram 4 by using the distortion amplitude detailed data 51 and the life data 52 and calculates the fatigue life curve 5 to predict the fatigue life of a detailed analysis target range (the component, the part of the product, etc.). The fatigue life prediction unit 63 is a processing unit that stores a prediction result 53 including information on the fatigue life curve 5 in the storage unit 130.

The distortion amplitude evaluation unit 64 is a processing unit that simulates the distortion amplitude at the cross section 1f at the location designated for the detailed model 1b and includes a setting unit 65, a projection unit 66, a distribution chart creation unit 67, and a distribution data output unit 68.

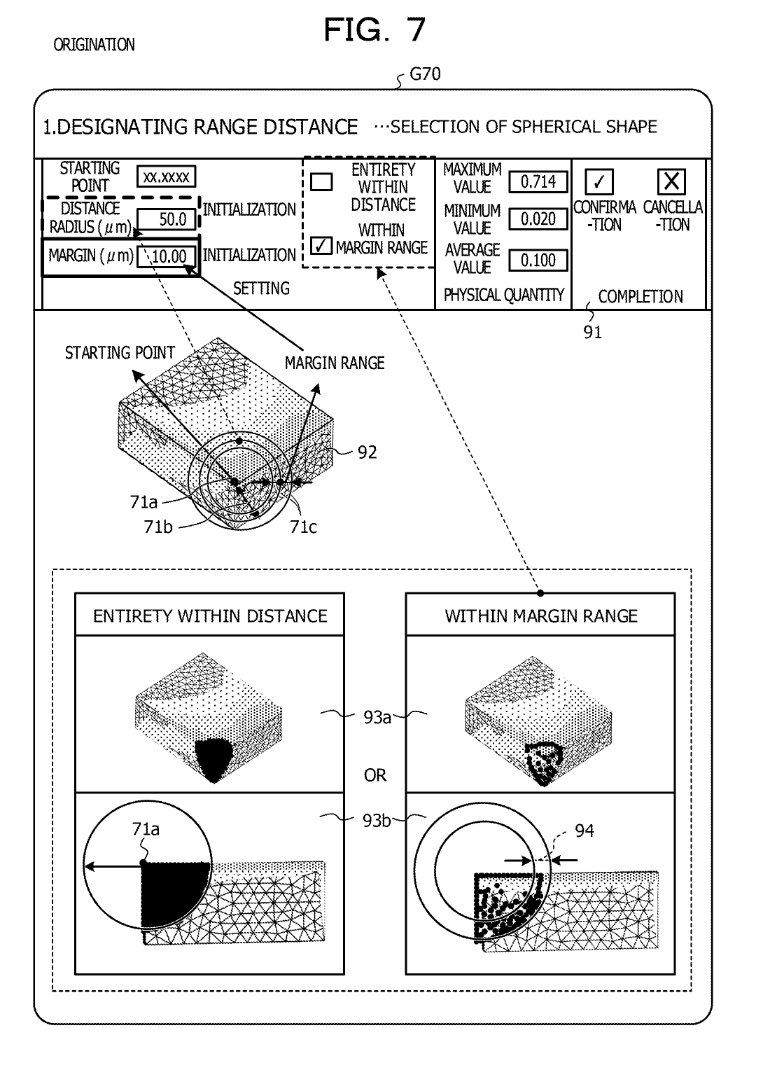

The setting unit 65 is a processing unit that acquires a starting point on the detailed model 1b, a distance (radius) from the starting point, and a margin (width) from a circumference based on the distance (radius). The setting unit 65 displays on the display device 15 a screen G70 (FIG. 7) in which the detailed model 1b to which the distortion amplitude detailed data 51 is reflected is drawn and the starting point, the distance (radius), and the margin may be set by the designer. The setting unit 65 stores the projection setting information 55 including information such as the starting point, the distance (radius), and the margin designated by the designer in the storage unit 130.

The projection unit 66 is a processing unit that generates the cross section 1f including the set starting point and projects information on nodes included in outer and inner margins of a circumference (arc) determined by the distance (radius) from the starting point on the cross section 1f onto the circumference. The information on the node may indicate at least the distortion amplitude and further, may indicate information such as stress or displacement. The projection unit 66 corresponds to an example of a movement unit that moves the setting.

By the projection unit 66, on the screen G70, the cross section 1f is drawn, and information at the node at a range of ±margin from the circumference is acquired from the distortion amplitude detailed data 51 on the circumference of the distance (radius) designated from the starting point on the cross section 1f based on the projection setting information 55, and the acquired information of the node is projected to the corresponding location on the circumference. Projection refers to changing coordinates of the node at a point where a straight line coupling the node from the starting point crosses the circumference. In the range of the margin, the post-projection node data 56 indicating information on the coordinate and the node after changing the node is stored in the storage unit 130.

The distribution chart creation unit 67 is a processing unit that creates a distribution based on the information of the node on the circumference drawn at the distance designated from the starting point of the cross section 1f. Regarding the cross section 1f, the information of each node included in the margin range for the circumference is expressed on the circumference based on the post-projection node data 56 and displayed on the screen G70. In the creation of the distribution chart, when the same plurality of coordinates exists in the post-projection node data 56, for example, the maximum value or an average value may be used.

The distribution data output unit 68 is a processing unit that outputs, in a table format, the distribution data expressed on the circumference based on the projection setting information 55 for the cross section 1f. The distribution data table 58 indicating the distribution data is output to the storage unit 130. The distribution data table 58 is a data file in a comma-separated values (CSV) format or the like. The distribution chart creation unit 67 and the distribution data output unit 68 correspond to an example of a creation display unit.

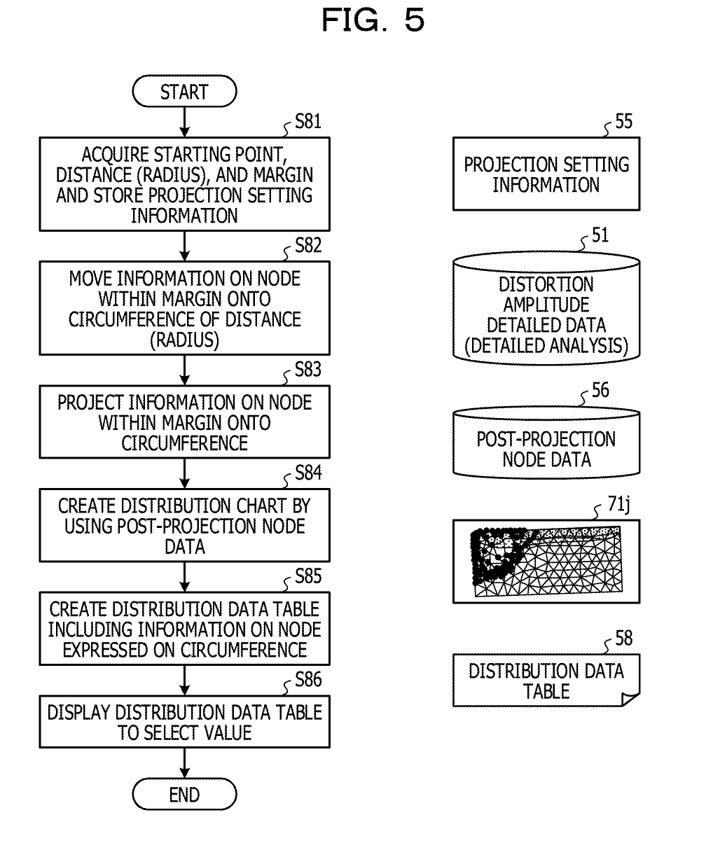

Next, the distortion amplitude evaluation process by the distortion amplitude evaluation unit 64 will be described. FIG. 5 is a flowchart for describing a distortion amplitude evaluation process. In FIG. 5, in the distortion amplitude evaluation unit 64, the setting unit 65 displays the screen G70 (FIG. 7) on the display device 15, acquires the starting point, the distance (radius), and the margin from the designer, and stores the projection setting information 55 in the storage unit 130 (step S81). As an example, in the case of the solder bump, the margin is approximately ±10 μm from the circumference with respect to a distance (radius) of approximately 50 μm.

The projection unit 66 moves the information of the node in the margin onto the circumference (step S82) and projects the information of the node within the margin onto the circumference (step S83). For example, from the distortion amplitude detailed data 51, the projection unit 66 acquires the coordinates of the nodes and the information on the nodes within the margin based on the projection setting information 55, changes the acquired coordinates of the nodes to the coordinates on the circumference, and stores the post-projection node data 56 indicating the changed coordinates and the information on the nodes in the storage unit 130.

The distribution chart creation unit 67 creates a distribution chart 71j by using the post-projection node data 56 and displays the created distribution chart 71j on the screen G70 (step S84). Within the margin range, the distribution chart 71j may be created by using the post-projection node data 56 and outside the margin range, the distribution chart may be created by using the distortion amplitude detailed data 51 and the entirety of the cross section 1f may be expressed by two distribution charts.

When the distribution chart 71j is created, it is preferable to perform the detailed analysis process 31b of the cross section 1f again for each node displayed in the post-projection node data 56. When the designer determines that an influence of an analysis result depending on projection of the node on the circumference is negligible within the margin range, the designer may omit the detailed analysis process 31b and use a result which already exists in the distortion amplitude detailed data 51.

The distribution data output unit 68 outputs the distribution data table 58 that indicates the data of the distribution chart 71j created by using the post-projection node data 56 to the storage unit 130 (step S85). The distribution data output unit 68 may display preprojection coordinates associated with the distribution data table 58 for each node and display the coordinates. Further, the distribution data output unit 68 selectably displays one or multiple values included in the distribution data table 58 on the display device 15 (step S86). Thereafter, the distortion amplitude evaluation process by the distortion amplitude evaluation unit 64 is terminated according to a termination operation of the user.

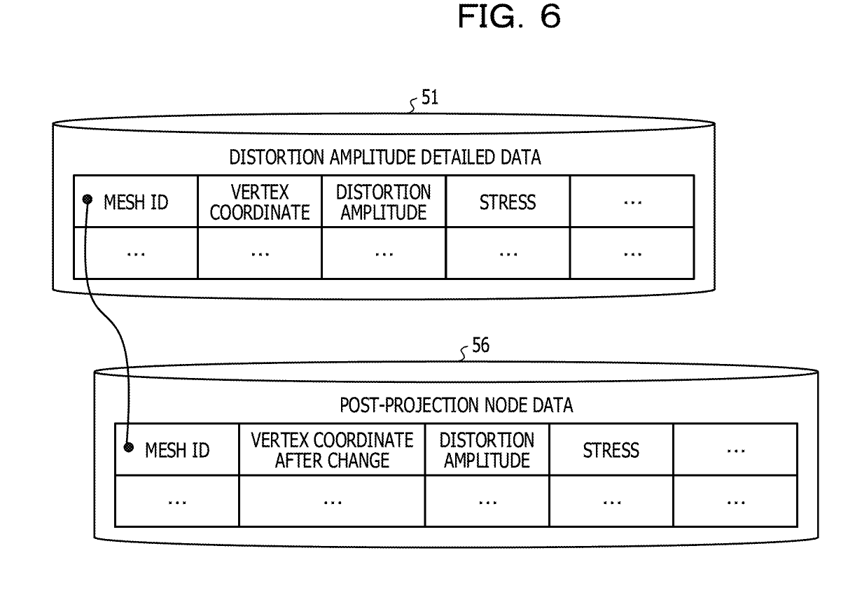

FIG. 6 is a diagram for describing a relationship between data. In FIG. 6, the distortion amplitude detailed data 51 obtained by the detailed analysis unit 61b is a database or the like representing the analysis result for each mesh ID, and has items such as a mesh ID, vertex coordinates, the distortion amplitude, and the stress.

The mesh ID indicates identification information of each mesh. The vertex coordinate indicates a node location of the mesh. The distortion amplitude indicates the value of the distortion amplitude for each node of each mesh obtained by the detailed analysis process 31b. The stress indicates the value of the stress which acts on the node of each mesh obtained by the detailed analysis process 31b.

The post-projection node data 56 is a database indicating an analysis result when the node within the margin moves onto the circumference for each mesh ID, etc. and has the items including the mesh ID, the vertex coordinate, the distortion amplitude, the stress, and the like. The mesh managed in the post-projection node data 56 corresponds to a part of the mesh included in the distortion amplitude detailed data 51.

The distortion amplitude detailed data 51 and the post-projection node data 56 are related to the mesh ID to associate an analysis result after projection with an analysis result before projection with respect to the mesh included in the post-projection node data 56.

FIG. 7 is a diagram illustrating a screen example for acquiring projection setting information. The screen G70 illustrated in FIG. 7 includes a basic area 91, a detailed model display area 92, and a result display area 93. The basic area 91 is an area that enables an input of the projection setting information 55, a display of a physical quantity, an operation of the screen G70, or the like by the designer.

The detailed model display area 92 is an area that displays the detailed model 1b based on the distortion amplitude detailed data 51. The result display area 93 displays a distribution of the distribution amplitude or the like based on the analysis result on the detailed model 1b based on the projection setting information 55 input into the basic area 91.

In the basic area 91, values of the starting point, the distance (radius), and the margin may be input and switching of the display of the simulation result before projection or the display of the simulation result after projection may be designated. Various setting values may be directly set by the designer or in the detailed model display area 92a, selection of the starting point, and the distance from the starting point, the margin from the circumference, or the like may be set by an operation of a mouse etc. Further, any one of “entirety within the distance” or “within the margin” is selectable, and as a result, the display of the result display area 93 is switchable.

In the detailed model display area 92, the detailed model 1b based on the distortion amplitude detailed data 51 is displayed. In FIG. 7, as a designation example of the designer, a starting point 71a, a circumference 71b by a distance (radius) for the starting point 71a, and a margin 71c for the circumference 71b are illustrated on the detailed model 1b.

The result display area 93 includes a first display area 93a that displays the detailed model 1b and a second display area 93b that displays a cross section at the starting point 71a. When the “entirety within the distance” of the basic area 91 is selected, a distribution targeting the entirety within the range of the distance 71b from the starting point 71a is displayed on the detailed model 1b in the first display area 93a, and a distribution targeting the entirety within the range of the distance 71b from the starting point 71a on the cross section is displayed in the second display area 93b.

When the “within the margin range” of the basic area 91 is selected, a distribution targeting “within margin range 94” on the detailed model 1b is displayed in the first display area 93a and a distribution within the margin range 94 on the cross section is displayed in the second display area 93b. Further, in the basic area 91, both the “entirety within the distance” and the “within the margin range” may be selectable. In this case, the first display area 93a and the second display area 93b may be respectively displayed in parallel.

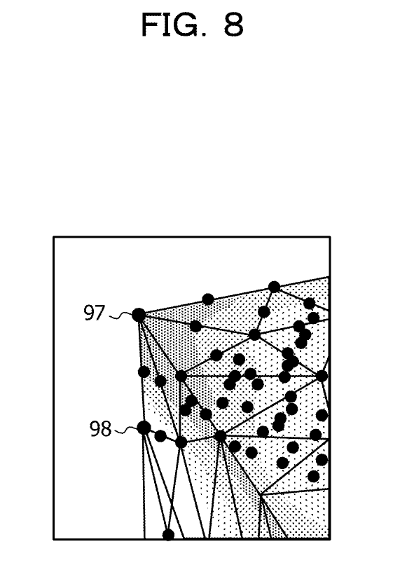

FIG. 8 is a diagram illustrating a distribution example within a distance. In FIG. 8, in the screen G70, a distribution example of the distortion amplitude when the user selects the “entirety within the distance” of the basic area 91 is illustrated. A plurality of points including points 97 and 98 indicates the node of the mesh and a node of a tetrahedral element or a hexahedral element generated on the basis of the determined mesh and the value of the distortion amplitude is calculated at each node.

In particular, since the point 97 indicates the node of the maximum value, the point 98 indicates the node of a minimum value, and the points 97 and 98 are displayed by different respective colors from other nodes, the user may visually know a location where the distortion amplitude is largest and a location where the distortion amplitude is smallest.

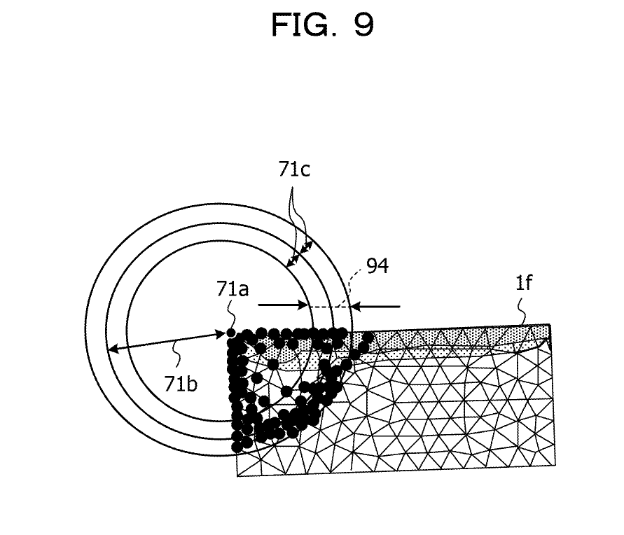

FIG. 9 is a diagram illustrating a distribution example within a margin range in a cross section. FIG. 9 illustrates an example of the cross section 1f of the starting point 71a where the distribution is displayed within the margin range 94 by the margin 71c set with respect to the circumference of the distance (radius) 71b from the starting point 71a. The distribution visually represents a dispersion of values indicating a strength of a factor depending on the fatigue life such as the distortion amplitude.

In the distribution in the cross section within the distance (FIG. 7), since the value of the distortion amplitude is represented in the entirety within the distance, the designer may not accurately extract a value to be acquired. Meanwhile, as illustrated in FIG. 9, in the distribution represented on the cross section 1f according to the embodiment, since a large number of distortion amplitude values are gathered on the circumference, it is easy to select the maximum value.

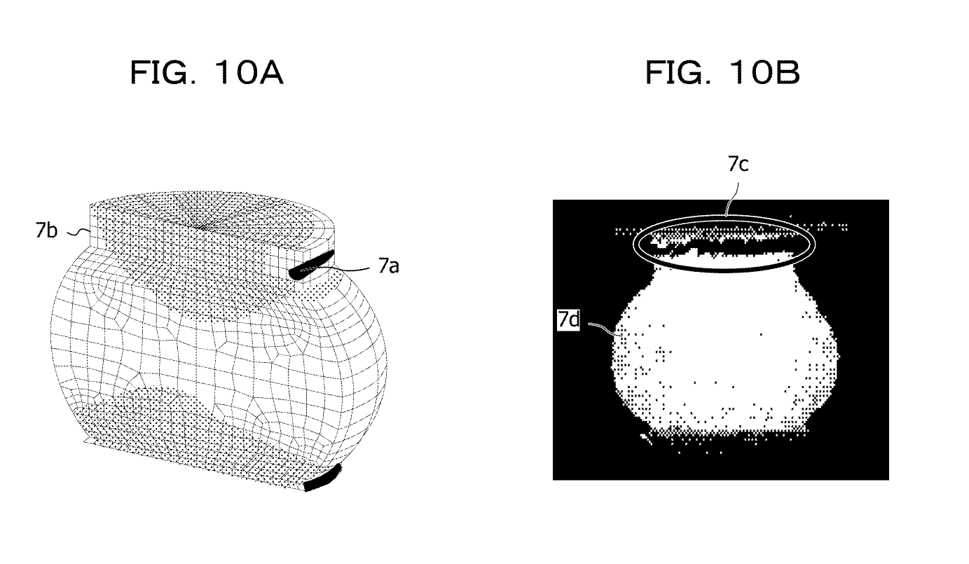

Next, a comparative example of the simulation result of the cross section and an experimental result is illustrated. FIGS. 10A and 10B are diagrams illustrating a comparative example in the case of a solder ball. FIG. 10A is a diagram illustrating a cross section 7b at the starting point 7a representing the largest distortion amplitude. Regarding the cross section 7b of FIG. 10A, the mesh is created so that the node is positioned on the circumference of the distance (radius) set from the starting point 7a and a result of analyzing the stress is represented.

FIG. 10B illustrates an actual measurement result when the solder ball is experimented. In an image of the cross section 7d, a breaking portion 7c generated by an experiment is illustrated. A distortion direction toward the inside from the starting point 7a of FIG. 10A and a shape of a captured breaking portion 7c coincide with each other.

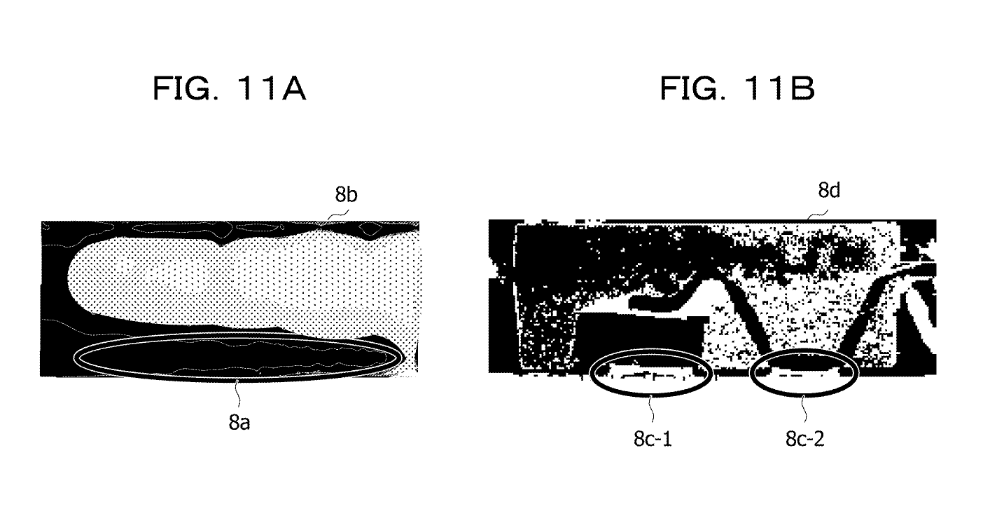

FIGS. 11A and 11B are diagrams illustrating a comparative example in the case of a bar-shaped solder. FIG. 11A illustrates a cross section 8b simulated in the case of the bar-shaped solder. In the cross section 8b, a portion 8a having a large distortion amplitude is illustrated.

FIG. 11B illustrates an actual measurement result when the bar-shaped solder is experimented. In an image of a cross section 8d, breaking portions 8c-1 and 8c-2 generated by the experiment are illustrated. A location and a shape of the portion 8a having the large distortion amplitude of FIG. 11A correspond to locations and shapes of the captured breaking portions 8c-1 and 8c-2.

In the embodiment, a technique of projecting information on a neighboring node onto the circumference may be adapted three-dimensionally. Even when the cross section is spherical, it is easy to cut the cross section and it is possible to appropriately obtain the information on the node from the spherical cross section.

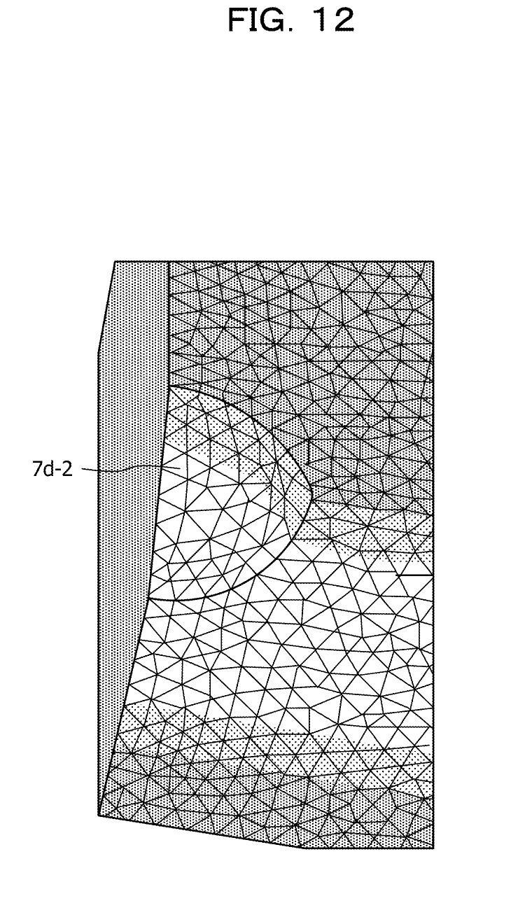

FIG. 12 is a diagram illustrating an example of a spherical cut surface. FIG. 12 illustrates, for example, a result obtained by cutting in a spherical shape in a distance (radius) set from the starting point 71a of FIG. 7 and performing a simulation by the stress analysis, etc. The maximum value of the distortion amplitude may be precisely acquired by projecting the neighboring node onto a cut surface 7d-2.

As described above, the designer merely projects the node in the vicinity of the circumference of the distance on the circumference using the distance (radius) set with respect to the starting point to easily create the cross section in which the distortion amplitude is represented. As a result, the designer verifies a cross section in which the starting point and the radius are arbitrarily changed to easily specify a cross section having a lot of distortion amplitudes. When an analysis of the life of the solder in the related art is performed by the related art, approximately 8 hours are taken, while when the life analysis is performed in the embodiment, the distribution chart on the cross section may be displayed with approximately 0.5 hours.

Accordingly, the node indicating the maximum value of the distortion amplitude may be easily extracted and the distribution chart may also be displayed within a short time. As a result, for example, a report may also be easily created.

The projection unit 66 in the embodiment corresponds to an example of the movement unit.

The present disclosure is not limited to the specifically disclosed embodiment and primary modifications and changes may be made without departing from the scope of the claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium storing a distortion calculation program that causes a computer to execute a process comprising:
analyzing a distortion which occurs in an object when stress is applied;
referring to a storage which stores a distortion amplitude for each of nodes of a mesh which is created for the object;
moving, onto a circumference which is determined by a set radius, one or more nodes within a width set from the circumference by using a point selected from the nodes of the mesh as a starting point;
creating a distribution chart of values of the distortion amplitude of the one or more nodes on the circumference after movement; and
displaying the distribution chart on a display device.

2. The non-transitory computer-readable recording medium according to claim 1, wherein in the moving, on a cross section of the object at the starting point, the circumference is determined by the starting point and the radius and each node within the width from the determined circumference moves onto the circumference.

3. The non-transitory computer-readable recording medium according to claim 2, wherein in the moving, for each of the one or more nodes within the width, the corresponding node moves to a point where a straight line coupling the corresponding node and the starting point crosses the circumference.

4. The non-transitory computer-readable recording medium according to claim 1, wherein in the moving, a spherical cut surface for the object is determined by using the radius from the starting point selected on the object and each of the one or more nodes within the width from the determined cut surface moves onto the cut surface.

5. The non-transitory computer-readable recording medium according to claim 4, wherein in the moving, for each of the one or more nodes within the width, the corresponding node moves to a point where a straight line coupling the corresponding node and the starting point crosses the spherical cut surface.

6. A distortion calculation method comprising:
analyzing, by a computer, a distortion which occurs in an object when stress is applied;
referring to a storage which stores a distortion amplitude for each of nodes of a mesh which is created for the object;
moving, onto a circumference determined by a set radius, one or more nodes within a width set from the circumference by using a point which is selected the nodes of the mesh as a starting point;
creating a distribution chart of values of the distortion amplitude of the one or more nodes on the circumference after movement; and
displaying the distribution chart on a display device.

7. The distortion calculation method according to claim 6, wherein the computer, on a cross section of the object at the starting point, determines the circumference by the starting point and the radius and projects each of the one or more nodes within the width from the determined circumference onto the circumference.

8. The distortion calculation method according to claim 7, wherein the computer, for each of the one or more nodes within the width, moves the corresponding node to a point where a straight line coupling the corresponding node and the starting point crosses the circumference.

9. The distortion calculation method according to claim 6, wherein the computer determines a spherical cut surface for the object by using the radius from the starting point selected on the object and projects each of the one or more nodes within the width from the determined cut surface onto the cut surface.

10. The distortion calculation method according to claim 9, wherein the computer, for each of the one or more nodes within the width, moves the corresponding node to a point where a straight line coupling the corresponding node and the starting point crosses the spherical cut surface.

11. An information processing apparatus calculating a distortion, the apparatus comprising:
a memory; and
a processor coupled to the memory and the processor configured to:
analyze a distortion which occurs in an object when stress is applied;
refer to a storage which stores a distortion amplitude for each of nodes of a mesh which is created for the object;
move, onto a circumference determined by a set radius, one or more nodes within a width which is set from the circumference by using a point selected from the nodes of the mesh as a starting point;
create a distribution chart of values of the distortion amplitude of the one or more nodes on the circumference after movement; and
display the distribution chart on a display device.

12. The information processing apparatus according to claim 11 wherein the processor, on a cross section of the object at the starting point, determines the circumference by the starting point and the radius and projects each of the one or more nodes within the width from the determined circumference onto the circumference.

13. The information processing apparatus according to claim 12, wherein the processor, for each of the one or more nodes within the width, moves the corresponding node to a point where a straight line coupling the corresponding node and the starting point crosses the circumference.

14. The information processing apparatus according to claim 11, wherein the processor determines a spherical cut surface for the object by using the radius from the starting point selected on the object and projects each of the one or more nodes within the width from the determined cut surface onto the cut surface.

15. The information processing apparatus according to claim 12, wherein the processor, for each of the one or more nodes within the width, moves the corresponding node to a point where a straight line coupling the corresponding node and the starting point crosses the spherical cut surface.
